(19) United States
(12) Patent Application Publication
(10) Pub. No.: US 2024/0338929 A1
(43) Pub. Date: Oct. 10, 2024

(54) METHOD AND SYSTEM FOR SELECTING ORAL HYGIENE TOOL

(71) Applicant: Oralic Supplies, Inc., Dover, DE (US)

(72) Inventors: Jun Lee, Diamond Bar, CA (US); Wenhong Felix Peng, Los Angeles, CA (US)

(21) Appl. No.: 18/408,641

(22) Filed: Jan. 10, 2024

Related U.S. Application Data
(60) Provisional application No. 63/494,104, filed on Apr. 4, 2023.

(51) Int. Cl. G06V 10/764; A61C 9/00; G06T 7/00

(52) U.S. Cl. CPC G06V 10/764; A61C 9/0006; G06T 7/0012; G06T 2207/20081; G06T 2207/30036; G06T 2207/30242

(57) ABSTRACT

Methods and systems for selecting a toothbrush or other oral hygiene product that particularly effective for a subject's dental condition are disclosed. The system maintains a data store comprising information for a plurality of toothbrushes, each of which is associated with a category. The system receives an image of the subject's teeth, parses the image to identify the subject's dental arch, and processes the image to classify the dental arch according to a one of a set of candidate classifications, such as regular, narrow, or shortened. The system uses the dental arch's classification to select, from the data store, a toothbrush having a category that is associated with the dental arch's classification, and it then provides the subject with the selected toothbrush.

### RELATED APPLICATIONS AND CLAIM OF PRIORITY

This patent document claims priority to U.S. provisional patent application No. 63/494,104, filed Apr. 4, 2023. The disclosure of the priority application is fully incorporated into this document by reference.

### BACKGROUND

Brushing teeth is a daily oral care habit of billions of people worldwide. The American Dental Association (ADA) recommends that people brush their at least teeth twice per day for two minutes each time, using a brush with soft bristles. Some people choose manual toothbrushes, while others chose electric toothbrushes. The ADA awards a seal of acceptance to toothbrushes that the ADA has evaluated for safety and efficacy.

However, outside of the basic categories of manual or electric, and stiff or soft, users generally select toothbrushes with brush heads that are similar in effect. While different bristle patterns, colors, stiffnesses, and sizes exist, users typically choose brush heads based on style and/or feel, not based on any assessment of expected clinical effectiveness of the particular brush head. Accordingly, improved methods of selecting toothbrush heads that will be effective for particular person are needed.

This document describes methods and systems that are directed to solving at least some of the issues described above.

### SUMMARY

In various embodiments, this document describes methods and systems for selecting a toothbrush or other oral hygiene product that particularly effective for a subject's dental condition.

In a first embodiment, the method includes accessing a data store comprising information for a plurality of toothbrushes, each of which is associated with a category. The method includes receiving image data of the subject's teeth, processing the image data to identify the subject's dental arch. The method also includes processing the image data to classify the dental arch according to a one of a set of candidate classifications, such as regular, narrow, or shortened. The method uses the dental arch's classification to select, from the data store, a toothbrush having a category that is associated with the dental arch's classification, and it then provides the subject with the selected toothbrush and/or information about the selected toothbrush.

In some embodiments, the candidate classifications comprise: (i) a first classification corresponding to a regular or wide arch; (ii) a second classification corresponding to a narrow arch; and (iii) a third classification corresponding to a truncated arch. Each of the candidate classifications may be associated with a corresponding angle.

Processing the image data to classify the dental arch may comprise measuring a plurality of angles formed between a plurality of combinations of teeth of the dental arch and selecting one of the candidate classifications that is associated with a smallest of the measured angles. Alternatively, processing the image data to classify the dental arch may comprise providing the image to a trained image classification model to return one or more candidate classifications. Embodiments that use a trained image classification model also may include training an image classification model on a plurality of labeled images of dental arches to generate the trained image classification model.

In some embodiments, processing the image data to identify the dental arch of the user comprises analyzing the image data to determine whether the image data shows at least a minimum number of teeth. If the image data shows at least the minimum number of teeth, the method may include determining that at least a portion of the teeth form the dental arch. If the image does not include at least the minimum number of teeth, the method may include prompting a user to retake the image until the user returns an image that includes at least the minimum number of teeth. If the image data is a camera image, prompting the user to retake the image may comprise prompting the user to use a digital camera to take a new image. If the image data is that of a dental impression tray, prompting the user to retake the image may comprise prompting the subject, or prompting a dental professional to instruct the subject, to bite down on a new dental impression tray.

In some embodiments, the method further comprises receiving additional information about the subject, and when selecting the toothbrush from the data store, also using the additional information to select the toothbrush. Optionally, receiving the additional information about the subject and using the additional information to select the toothbrush may comprise determining an age status of the subject, and then selecting a toothbrush that is associated with the age status of the subject. Optionally, receiving the additional information about the subject and using the additional information to select the toothbrush may comprise parsing the image to determine a spacing classification of the teeth of the subject, and then selecting a toothbrush that is also associated with the spacing classification. Optionally, receiving the additional information about the subject and using the additional information to select the toothbrush may comprise determining whether the subject has braces, and then selecting a toothbrush that is associated with braces. Optionally, receiving the additional information about the subject and using the additional information to select the toothbrush may comprise: (a) determining whether the subject has a specified dental condition, wherein the dental condition comprises one or more of the following: gum disease, furcation, or back triangle; and (b) selecting a toothbrush that is also associated with the specified dental condition.

Various embodiments also include methods of treating a dental patient using any of the methods described above.

Various embodiments also include computer program products containing programming instructions for implementing any of the methods described above. Various embodiments also include systems that include processors, data stores, and computer program products containing programming instructions for implementing any of the methods described above.

### BRIEF DESCRIPTION OF THE DRAWINGS

FIG. 1 illustrates various aspects of a system that may be used to select an oral hygiene tool for a person.

FIG. 2 is a flowchart illustrating various steps that the disclosed methods of selecting an oral hygiene tool may include.

FIGS. 3A-3C illustrate example classifications of arch shapes, and how the system may perform measurements to classify an arch shape.

FIG. 4 illustrates an example data structure that the system's data store may use.

FIGS. 5A and 5B show three examples of toothbrush heads that differ from each other in bristle pattern arrangements.

FIG. 6 depicts example hardware components that may be included in any of the electronic devices of the system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when the components are together oriented in a first way. The relative orientations of the components may be reversed, or the components may be on the same plane, if the orientation of the structure that contains the components is changed. The claims are intended to include all orientations containing such components.

Additional terms that are relevant to this disclosure will be defined at the end of this Detailed Description section.

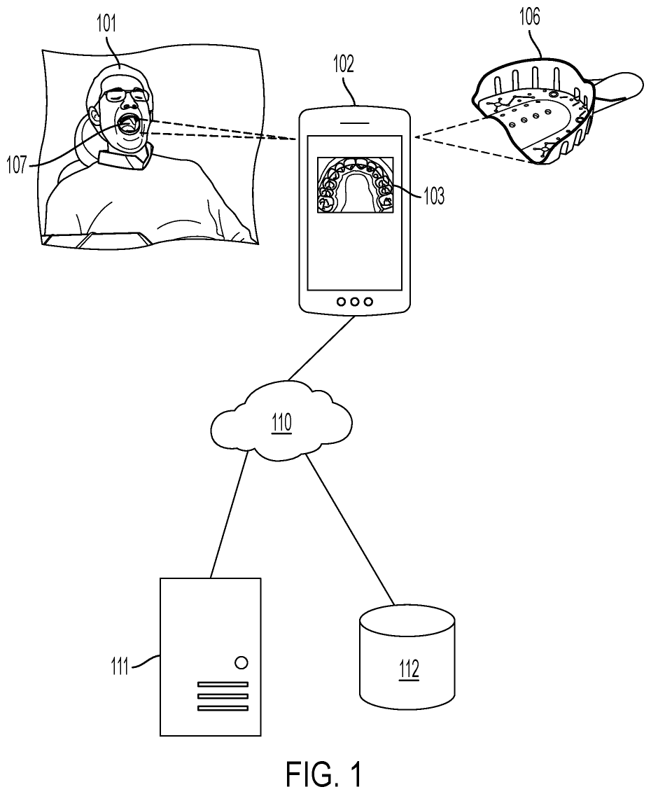

FIG. 1 illustrates various aspects of a system that may be used to select a toothbrush or other oral hygiene tool for a subject 101. The subject 101 may be a person who is selecting a tool for themselves, or it may be a patient of a dental professional who is selecting the tool for the patient. As shown, an electronic device 102 will capture or otherwise receive image data 103 for the teeth inside the subject's mouth 107. The device 102 may use a camera to capture the image data 103 while the subject's mouth 107 is in the camera's field of view. In some embodiments, the device 102 may include a lidar system, in which case the image data may be a three-dimensional lidar point cloud. Alternatively, the device 102 may receive the images from an electronic device in an electronic message sent via one or more communication networks 110. As yet another alternative, if an image of the subject's mouth 107 was not taken but instead the subject bit down on an impression tray 106, then the device 102 may receive or scan one or more images of the impression tray 106.

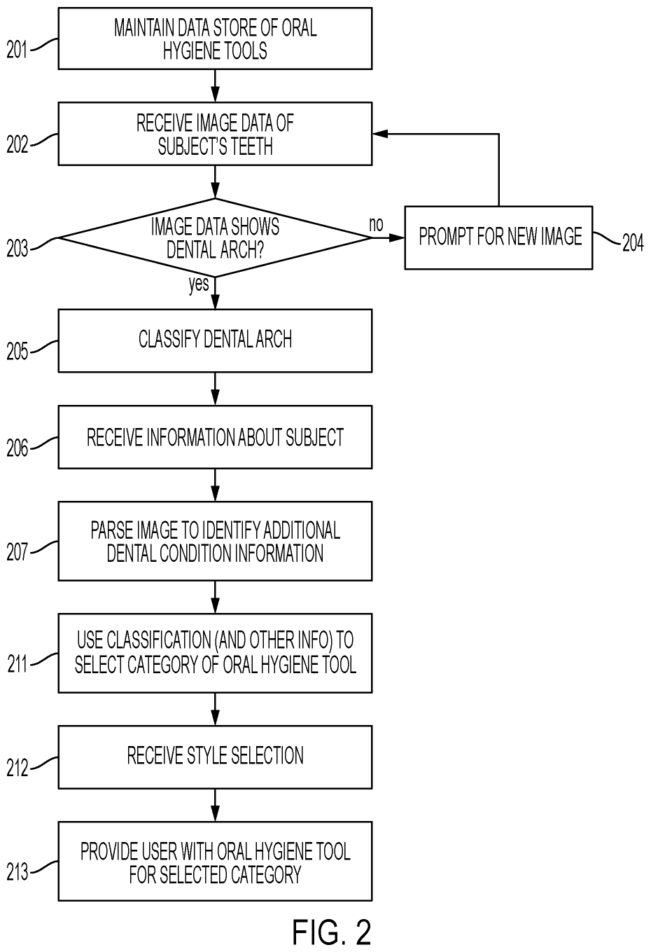

The electronic device 102 will include computing device components, or it will be in communication with a remote computing device 111 with such components, that will process the images to analyze the subject's teeth and recommend an oral hygiene tool based on that analysis. Methods by which the computing device(s) may do this will be described below in the discussion of FIG. 2. The system also will include a data store 112 made up of one or more memory devices that store data about various oral hygiene tools, along with associations of each tool with a category and other data elements.

FIG. 2 is a flowchart illustrating various steps that the disclosed methods of selecting an oral hygiene tool may include. As noted in FIG. 1 above, at 201 the system will maintain a data store with data for oral hygiene tools. The data store will include identifying information for each tool, such as a product name and/or a code such as a universal product code (UPN), Amazon standard identification number (ASIN), or other code.

At 202 the system will receive image data that includes one or more images that include all or substantially all of a subject's teeth. In this document, the term “subject” refers to a person whose teeth are being analyzed. The subject may be a person who is a patient of a dental professional, or a consumer who is searching for an oral hygiene product that is suitable for their dental condition. The images may include images of the patient's upper arch, lower arch, or both. Optionally, the image or images of either of the patient's arches may be a composite of multiple images captured from a camera that was in multiple positions, to fully or nearly fully capture all teeth of the arch. This document may use the term “image data” to generally refer to a single image, multiple images and/or a composite image, depending on what is available for the system to process.

At 203 the system will parse the image data to identify a dental arch of the user. To do this, the system may use any suitable image processing algorithm or to identify the patient's teeth and other oral structures. The system may use an intelligent image classification model that has been trained using labeled image data of dental arches, such as those available using the TensorFlow library, the OpenCV image processing algorithms, or Caffe. If the system does not recognize a dental arch in the image data, or if the image data does not include at least a minimum number of teeth (such as ten teeth), then at 204 the system will prompt the user to take one or more additional images until the user returns suitable image data (such as a image data that includes at least the minimum number of teeth). For example, the system may prompt the user to take multiple images of the patient's arch in which the camera is positioned at different positions and/or angles with respect to the subject's mouth. When the system has received a group of images that collectively show all or substantially all of the teeth of the patient's arch, the system may generate a composite image using any now or hereafter known image stitching or other compositing technique.

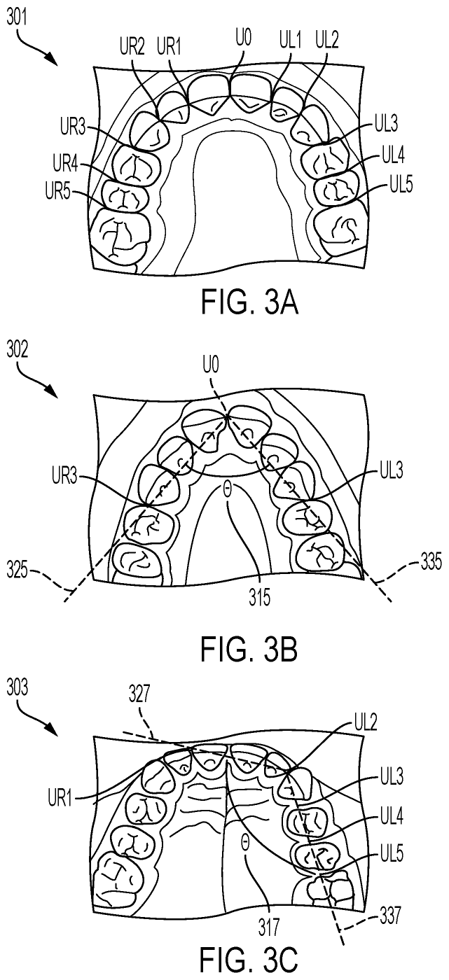

An example suitable image is shown in FIG. 3A, in which a subject's dental arch 301 includes a set of upper (maxillary) teeth with contact points including: contact point U0, representing the point where the two central incisors contact each other; contact points UR1 and UL1, representing the point where each central incisor contacts an adjacent lateral incisor, and contact points UR2-UR5 and UL2-UL5, representing the points where each posterior tooth contacts an adjacent tooth. If the subject's dental arch includes any gaps between teeth (as is shown in dental arch 303 of FIG. 3C at contact points such as UL3, UL4, and UL5), then the system may use a midpoint of the gap as the “contact point” for the two teeth on either side of that gap.

As noted above, the image data may be one or more images of the subject's mouth as captured by a camera, or it may be an image of an impression in a dental tray that the subject bit. If the image data is that of the subject's mouth, then at 205 the system will prompt the user to use a digital camera to take one or more new images. If the image data that of a dental impression, then at 205 the system will prompt the user to have the subject bite down on a new dental impression tray. In either case, the user may be the actual subject, or it may be a dental professional (such as a dentist or dental hygienist) who is treating the subject as a patient.

At 205, once the system has received suitable image data of the subject's dental arch, the system will process the image data to classify the dental arch. The system may have several candidate classifications to choose from, such as wide, a narrow, or shortened. An example of a wide arch 301, which is sometimes referred to in the dental field as a typical or regular arch, is shown in FIG. 3A. An example of a narrow arch 302 is shown in image of FIG. 3B. An example of a shortened arch 303, which is sometimes referred to in the dental field as a truncated arch, is shown in FIG. 3C.

The system may perform the classification using a trained model that has been trained using labeled image data of dental arches, such as those described above.

Alternatively, or in addition, with reference to FIGS. 3B and 3C, to classify the dental arch the system may process the image to identify the teeth and contact points (U0, UR1-UR5 and UL1-UL5) in the image, measure an angle for each tooth contact point, and classify the image according to the size of the smallest of the measured angles.

The system may determine the angles in any number of ways, so long as the system uses a process for classifying all possible angles that is consistent across the possible angles. For example, in this process, each angle may use the contact point as the vertex, and the rays of the angle will pass through another contact point as follows: for each vertex, the system may count three contact points and/or pass through three teeth from the vertex from each side of the contact point (i.e., toward the left side of the arch and toward the right side of the arch). One ray of the angle will pass through the third contact point to the right side of the vertex, and the other ray of the angle will pass through the third contact point to the left side of the vertex. If fewer than three teeth are available on the image on either side of the vertex, then instead of the number three the system may use the maximum number of teeth or contact points that appear in the image.

For example, see FIG. 3B, in which the angle 315 is formed by a first ray 325 extending from a vertex positioned at contact point U0 through contact point UR3 and a second ray 335 extending from contact point U0 through contact point UL3. In FIG. 3C, the angle 317 is formed by a first ray 327 extending from a vertex positioned at contact point UL2 through contact point UR1 and a second ray 337 extending from the vertex at contact point UL2 through contact point UL5. The system would similarly measure angles for each combination of a right side contact point and a left side contact point with vertex contact point U0.

Notably, some contact points may be more than just a single point but instead may be an edge along which two teeth contact each other. If so, the system may select a particular location along the edge, such as the midpoint, to be the contact point. In addition, if the image captures a tooth (such as incisor) at an angle showing both bottom and side of the tooth, that tooth may have multiple contact edges appearing in the image. In any such situation, the system may select a location such as the corner (i.e., the junction point of) the two edges as the contact point. Other locations may be used to define the contact points so long as the system identifies the contact points for similarly viewed teeth in a consistent way.

In addition, instead of using contact points between teeth to draw the rays of the angle, the system may use the central points, innermost edges, or outermost edges of the teeth to draw one or both rays of the angle. The specific location of points used are not critical so long as the system uses a consistent process to determine all angles of the subject's dental arch.

Once the system measures all angles of the arch, the system may then select one of the candidate classifications that is associated with the smallest measured angle. For example, if the smallest measured angle is equal to or greater than an upper threshold, the system may classify the dental arch as a shortened arch (as in arch 303 of FIG. 3C). If the angle is equal to or less than a lower threshold, the system may classify the dental arch as a narrow arch (as in arch 302 of FIG. 3B). If the angle is between the lower and upper thresholds, the system may classify the dental arch as a regular arch (as in arch 301 of FIG. 3A).

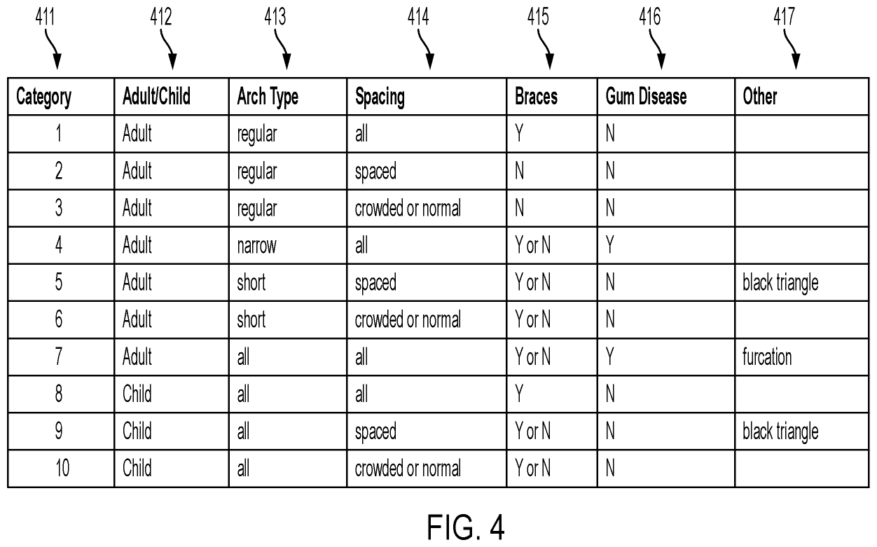

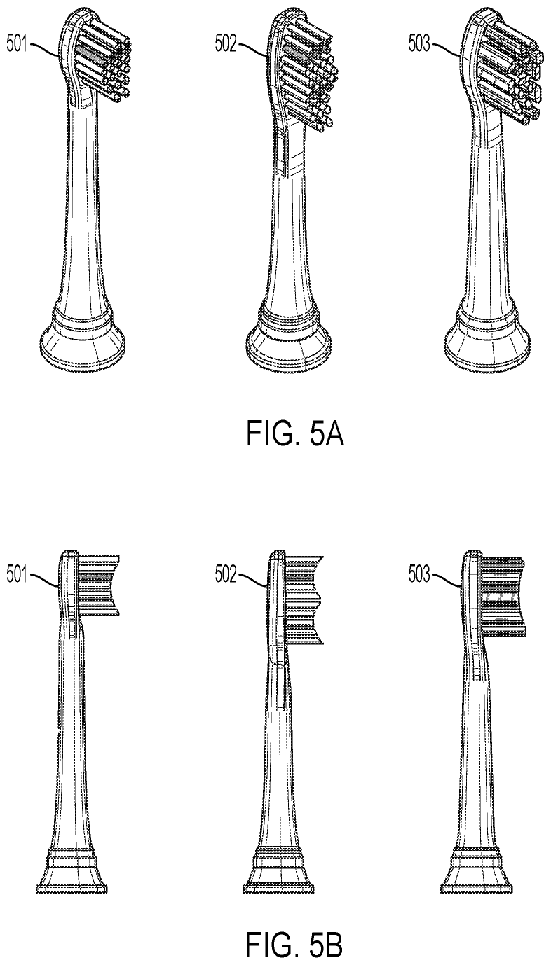

Returning to FIG. 2, at 211 the system will use the selected classification of the patient's dental arch to select, from the database, an oral hygiene tool having a category that is associated with the selected classification of the subject. FIG. 4 illustrates an example data structure that the system's data store may use to do this, in which ten categories 411 of tools (specifically, toothbrushes), numbered 1 through 10, are listed. Each category will be associated with a tool having certain known characteristics. For example, some categories may be associated with toothbrushes that have relatively softer, or relatively stiffer, bristles than those toothbrushes of other categories. Some categories may be for toothbrushes that have relatively longer, or relatively shorter, bristles than those of other categories. Some categories may be for toothbrushes that have bristles that are arranged in a particular pattern, or with specifically located variations in heights. This is shown by way of example in FIGS. 5A and 5B, which show three examples of toothbrush heads 501-503 that differ from each other in bristle pattern arrangements. FIG. 5A shows perspective views of the toothbrush heads 501-503, while FIG. 5B shows side views of the toothbrush heads 501-503. The toothbrush heads shown in FIGS. 5A and 5B are merely examples; additional and/or alternative brush heads may be used in various embodiments.

Returning to FIG. 4, in the data store each category 411 is associated with at least one arch type 413. If only one category 411 is associated with the subject's arch type, then the system will return information about the toothbrushes for that category. If multiple categories 411 are associated with the subject's arch type, then the system may obtain additional information about the subject and use that information to select the category. For example, with reference to both FIGS. 2 and 4, at 206 the system may receive information about the subject, whether from the subject itself via a user interface, from the subject's dental professional via a user interface, or from another source such as a stored profile of the subject. The information may include information about the subject's age status (such as whether the subject is a child or adult 412), whether the subject has braces 415, whether the subject has gum disease 416, or whether the subject has another dental condition such as furcation or a particular spacing between the front incisors known as “black triangle.”

At 207 the system may parse the image to receive some or all of the information about the subject. For example, the system may identify whether or not the subject has braces 415 or gum disease 416, or whether the patient's spacing 414 between teeth is considered to be wide, crowded, or normal, using image processing steps such as those described above. Optionally, when determining the subject's teeth spacing, the system may also assess the subject's tooth size (i.e., average size, or the size of particular teeth), and the system may determine the spacing relative to the subject's tooth size. The system may also look for other conditions associated with he patient's teeth, such as an enamel erosion condition known as “cupping”.

If the system has any of this additional information, it may select the oral hygiene tool category 411 that matches both the subject's arch type 414 and one or more of the additional information points. Optionally, the system may use some of the additional information to eliminate one or more categories from consideration. For example, if the subject is an adult, the system may eliminate all categories that are designed for individuals whose age status of is that of a child; if the subject is a child the system may eliminate all categories that are designed for individuals whose age status is that of an adult. In addition, some dental conditions may take priority over others, optionally including arch type. For example, if the patient has braces, the system may select a brush head category that is appropriate for braces, regardless of whether that category is associated with the subject's arch type.

Optionally, the system may include some brush categories associated with arch type, and subcategories that are associated with identified other information (such as spacing or cupping). For example, if a patient has a wide arch and gapped teeth, the system may select a brush from the wide arch category that is appropriate for gapped teeth. A brush having relatively narrower, longer, and stiffer bristles than those of other brushes in the wide arch category may be selected for a subject having a wide arch and gapped teeth.

Returning to FIG. 2, at 213 the system will provide the subject with the selected oral hygiene tool. The system may do this as part of an online tool that helps the subject select and place an order for a toothbrush (i.e., a manual toothbrush or a brush head for an electric toothbrush) that corresponds to the patient's dental condition. For example, the system may generate an electronic message, or output via a user interface, information identifying the selected oral hygiene tool. The user interface may include a display and input device such as a microphone, keyboard or touch pad. Alternatively or in addition, the user interface may include a smart speaker that may output the information via an audio prompt. The user interface may include or be associated with an electronic shopping cart that is part of an e-commerce platform. The subject may select or approve placement of the identified oral hygiene tool into the shopping cart, and then use the shopping cart to order the toothbrush. Alternatively, the system may automatically cause the e-commerce platform to order the oral hygiene tool without requiring the user to actively place the order. Alternatively, the system may implement step 213 by providing a recommendation with information about the toothbrush to the subject's dental professional, who will provide or arrange to provide the patient with the selected brush as part of a course of treating the patient's dental condition. Other methods to provide the subject with the selected tool may be used.

Optionally, before providing the subject with the selected tool, at 212 the system may give the subject or other user the option to choose from one or more available styles for the tool, such as bristle colors or patterns. Then, when providing the subject with the selected oral hygiene tool at 213, the system will provide the subject with the selected tool in the selected style.

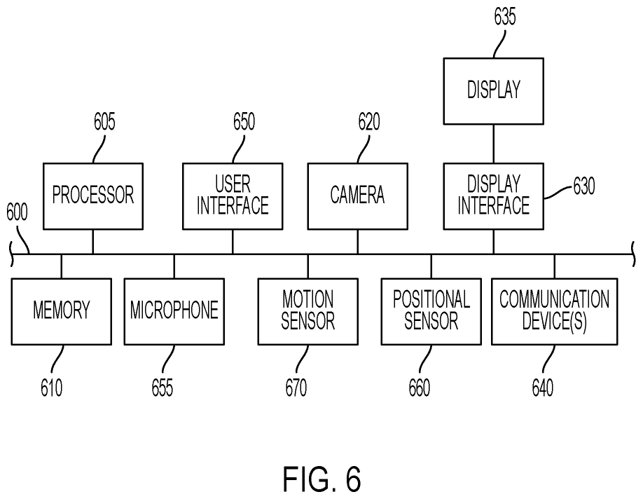

FIG. 6 depicts an example of internal hardware components that may be included in any of the electronic devices of the system, such as the mobile computing device 102 or remote computing device 111 of FIG. 1. An electrical bus 600 serves as a communication path via which messages, instructions, data, or other information may be shared among the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 615. A memory device may include a single device or a collection of devices across which data and/or instructions are stored.

An optional display interface 630 may permit information from the bus 600 to be displayed on a display device 635 in visual, graphic or alphanumeric format. An audio interface and audio output (such as a speaker) also may be provided. Communication with external devices may occur using various communication devices 640 such as a wireless antenna, a radio frequency identification (RFID) tag and/or short-range or near-field communication transceiver, each of which may optionally communicatively connect with other components of the device via one or more communication systems. The communication device 640 may be configured to be communicatively connected to a communications network, such as the Internet, a local area network or a cellular telephone data network.

The hardware may also include a user interface sensor 650 that allows for receipt of data from (or that includes) input devices such as a keyboard, a mouse, a joystick, a touchscreen, a touch pad, a remote control, a pointing device and/or microphone. Digital image frames also may be received from a camera 620 that can capture video and/or still images. The system also may include a positional sensor 660 and/or motion sensor 670 to detect position and movement of the device. Examples of motion sensors 670 include gyroscopes or accelerometers. Examples of positional sensors 660 include a global positioning system (GPS) sensor device that receives positional data from an external GPS network.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described in this document.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 5.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the term “camera” refers generally to a hardware sensor that is configured to acquire digital images. For example, an imaging device can be held by a user such as a DSLR (digital single lens reflex) camera, cell phone camera, or video camera. The camera may be part of a system or device that includes other hardware components. For example, a camera can be mounted on an accessory such as a monopod or tripod, or part of a smartphone or tablet computing device.

A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems use various types of statistical analyses, machine learning systems are distinguished from statistical analyses by virtue of the ability to learn without explicit programming and being rooted in computer technology.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments for implementing a hybrid spreadsheet and coding environments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

Without excluding further possible embodiments, certain example embodiments are summarized in the following clauses:

Clause 1: A method for selecting a toothbrush for a subject comprises: (a) maintaining a data store comprising information for a plurality of toothbrushes, each of which is associated with a category; (b) receiving image data that shows a plurality of teeth of the subject; (c) processing the image data to identify a dental arch of the subject; (d) processing the image data to classify the dental arch according to a classification that is selected from a plurality of candidate classifications; (e) using the selected classification to select, from the data store, a toothbrush having a category that is associated with the selected classification of the subject's dental arch; and (f) providing the subject with the selected toothbrush, information about the selected toothbrush, or both.

Clause 2: The method of clause 1, wherein the plurality of candidate classifications comprise: (a) a first classification corresponding to a regular or wide arch; (b) a second classification corresponding to a narrow arch; and (c) a third classification corresponding to a truncated arch.

Clause 3: The method of clause 2, wherein each of the candidate classifications is associated with a corresponding angle, and processing the image data to classify the dental arch comprises (a) measuring a plurality of angles formed between a plurality of combinations of teeth of the dental arch, and (b) selecting one of the candidate classifications that is associated with a smallest of the measured angles.

Clause 4: The method of clause 2, wherein processing the image data to classify the dental arch comprises providing the image data to a trained image classification model to return one or more candidate classifications.

Clause 5: The method of clause 4, further comprising training an image classification model on a plurality of labeled images of dental arches to generate the trained image classification model.

Clause 6: The method of any of clauses 1-5, wherein processing the image data to identify the dental arch of the user comprises analyzing the image data to determine whether the image data shows at least a minimum number of teeth. If the image data shows at least the minimum number of teeth, the method includes determining that at least a portion of the teeth form the dental arch. If the image data does not include at least the minimum number of teeth, the method includes prompting a user to take one or more additional images until the user returns image data that shows at least the minimum number of teeth.

Clause 7: The method of clause 6, wherein either: (a) the image data is from a camera image, and prompting the user to take the one or more additional images comprises prompting the user to use a digital camera to take a new image; or (b) the image data is that of a dental impression tray, and prompting the user to take the one or more additional images comprises prompting the subject, or prompting a dental professional to instruct the subject, to bite down on a new dental impression tray.

Clause 8: The method of any of clauses 1-7, further comprising receiving additional information about the subject and, when selecting the toothbrush from the data store, also using the additional information to select the toothbrush.

Clause 9: The method of clause 8, wherein receiving the additional information about the subject and using the additional information to select the toothbrush comprises determining an age status of the subject and only selecting a toothbrush that is associated with the age status of the subject.

Clause 10: The method of clause 8, wherein receiving the additional information about the subject and using the additional information to select the toothbrush comprises (a) processing the image data to determine a spacing classification of the teeth of the subject, and (b) selecting a toothbrush that is also associated with the spacing classification.

Clause 11: The method of clause 8, wherein receiving the additional information about the subject and using the additional information to select the toothbrush comprises determining whether the subject has braces, and only selecting a toothbrush that is associated with braces.

Clause 12: The method of clause 8, wherein receiving the additional information about the subject and using the additional information to select the toothbrush comprises (a) determining whether the subject has a specified dental condition, wherein the dental condition comprises one or more of the following: gum disease, furcation, or back triangle, and (b) selecting a toothbrush that is also associated with the specified dental condition.

Clause 13: A method of treating a dental patient comprising the method of any preceding clause.

Clause 14: A system comprising a memory device containing programming instructions that are configured to, upon execution by a processor, cause the processor to implement the method of any of clauses 1-12.

Clause 15: The system of clause 14, wherein the instructions to process the image data to classify the dental arch comprise instructions to provide the image to a trained image classification model to return one or more candidate classifications.

Clause 16: The system of clause 14 or 15, wherein the instructions to process the image data to identify the dental arch of the user comprise instructions to analyze the image data to determine whether the image data shows at least a minimum number of teeth. If the image data shows at least the minimum number of teeth, the instructions will cause the processor to determine that at least a portion of the teeth form the dental arch. If the image data does not show at least the minimum number of teeth, the instructions will cause the processor to prompt a user to provide a new image until the user returns an image that includes at least the minimum number of teeth.

Clause 18: The system of any of clauses 14-17, further comprising instructions to, in response to receiving additional information about the subject, when selecting the toothbrush from the data store, also use the additional information to select the toothbrush and only selecting a toothbrush that corresponds to the additional information. The additional information comprises one or more of the following: (a) an age status of the subject; (b) a spacing classification of the teeth of the subject; (c) an indication that the subject has braces; or (d) an indication that the subject has a dental condition that comprises one or more of the following: gum disease, furcation, or back triangle.

Clause 19: The system of any of clauses 14-18, further comprising additional programming instructions that are configured to place the toothbrush in a shopping cart of an e-commerce platform.

Clause 20: A system comprising: (a) a data store comprising information for a plurality of toothbrushes, each of which is associated with a category; (b) a processor; and (c) a memory containing programming instructions according to any of clauses 14-19, and which further cause the processor to output, via a user interface, information identifying the toothbrush.

1. A method for selecting a toothbrush for a subject, the method comprising:
maintaining a data store comprising information for a plurality of toothbrushes, each of which is associated with a category;
receiving image data that shows a plurality of teeth of the subject;
processing the image data to identify a dental arch of the subject;
processing the image data to classify the dental arch according to a classification that is selected from a plurality of candidate classifications;
using the selected classification to select, from the data store, a toothbrush having a category that is associated with the selected classification of the subject's dental arch; and
providing the subject with the selected toothbrush, information about the selected toothbrush, or both.

2. The method of claim 1, wherein the plurality of candidate classifications comprise:
a first classification corresponding to a regular or wide arch;
a second classification corresponding to a narrow arch; and
a third classification corresponding to a truncated arch.

3. The method of claim 2, wherein:
each of the candidate classifications is associated with a corresponding angle; and
processing the image data to classify the dental arch comprises:
measuring a plurality of angles formed between a plurality of combinations of teeth of the dental arch, and
selecting one of the candidate classifications that is associated with a smallest of the measured angles.

4. The method of claim 2, wherein processing the image data to classify the dental arch comprises providing the image data to a trained image classification model to return one or more candidate classifications.

5. The method of claim 4, further comprising training an image classification model on a plurality of labeled images of dental arches to generate the trained image classification model.

6. The method of claim 1, wherein processing the image data to identify the dental arch of the user comprises:
analyzing the image data to determine whether the image data shows at least a minimum number of teeth;
if the image data shows at least the minimum number of teeth, determining that at least a portion of the teeth form the dental arch; and
if the image data does not include at least the minimum number of teeth, prompting a user to take one or more additional images until the user returns image data that shows at least the minimum number of teeth.

7. The method of claim 6, wherein either:
the image data is from a camera image, and prompting the user to take the one or more additional images comprises prompting the user to use a digital camera to take a new image; or
the image data is that of a dental impression tray, and prompting the user to take the one or more additional images comprises prompting the subject, or prompting a dental professional to instruct the subject, to bite down on a new dental impression tray.

8. The method of claim 1, further comprising:
receiving additional information about the subject; and
when selecting the toothbrush from the data store, also using the additional information to select the toothbrush.

9. The method of claim 8, wherein receiving the additional information about the subject and using the additional information to select the toothbrush comprises:
determining an age status of the subject; and
only selecting a toothbrush that is associated with the age status of the subject.

10. The method of claim 8, wherein receiving the additional information about the subject and using the additional information to select the toothbrush comprises:
processing the image data to determine a spacing classification of the teeth of the subject; and
selecting a toothbrush that is also associated with the spacing classification.

11. The method of claim 8, wherein receiving the additional information about the subject and using the additional information to select the toothbrush comprises:
determining whether the subject has braces; and
only selecting a toothbrush that is associated with braces.

12. The method of claim 8, wherein receiving the additional information about the subject and using the additional information to select the toothbrush comprises:
determining whether the subject has a specified dental condition, wherein the dental condition comprises one or more of the following: gum disease, furcation, or back triangle; and
selecting a toothbrush that is also associated with the specified dental condition.

13. A method of treating a dental patient comprising the method of claim 1.

14. A system comprising a memory device containing programming instructions that are configured to, upon execution by a processor, cause the processor to:
access a data store comprising information for a plurality of toothbrushes, each of which is associated with a category; and
upon receiving image data that shows a plurality of teeth of the subject:
process the image data to identify a dental arch of the subject,
process the image data to classify the dental arch according to a classification that is selected from a plurality of candidate classifications,
use the selected classification to select, from the data store, a toothbrush having a category that is associated with the selected classification of the subject's dental arch, and
output, via a user interface, information identifying the toothbrush.

15. The system of claim 14, wherein:
the plurality of candidate classifications comprise:
a first classification corresponding to a regular or wide arch,
a second classification corresponding to a narrow arch, and
a third classification corresponding to a truncated arch;
each of the candidate classifications is associated with a corresponding angle; and
the instructions to process the image data to classify the dental arch comprise instructions to:
measure a plurality of angles formed between a plurality of combinations of teeth of the dental arch, and
select one of the candidate classifications that is associated with a smallest of the measured angles.

16. The system of claim 14, wherein the instructions to process the image data to classify the dental arch comprise instructions to provide the image to a trained image classification model to return one or more candidate classifications.

17. The system of claim 14, wherein the instructions to process the image data to identify the dental arch of the user comprise instructions to:
analyze the image data to determine whether the image data shows at least a minimum number of teeth;
if the image data shows at least the minimum number of teeth, determine that at least a portion of the teeth form the dental arch; and
if the image data does not show at least the minimum number of teeth, prompt a user to provide a new image until the user returns an image that includes at least the minimum number of teeth.

18. The system of claim 14, further comprising instructions to, in response to receiving additional information about the subject:
when selecting the toothbrush from the data store, also use the additional information to select the toothbrush and only selecting a toothbrush that corresponds to the additional information,
wherein the additional information comprises one or more of the following:
an age status of the subject,
a spacing classification of the teeth of the subject,
an indication that the subject has braces, or
an indication that the subject has a dental condition that comprises one or more of the following: gum disease, furcation, or back triangle.

19. The system of claim 14, further comprising additional programming instructions that are configured to place the toothbrush in a shopping cart of an e-commerce platform.

20. A system, comprising:
a data store comprising information for a plurality of toothbrushes, each of which is associated with a category;
a processor; and
a memory containing programming instructions that are configured to, upon execution by a processor, cause the processor to, upon receiving image data that shows a plurality of teeth of the subject:
process the image data to identify a dental arch of the subject,
process the image data to classify the dental arch according to a classification that is selected from a plurality of candidate classifications,
use the selected classification to select, from the data store, a toothbrush having a category that is associated with the selected classification of the subject's dental arch, and
output, via a user interface, information identifying the toothbrush.
